(19) United States
(12) Patent Application Publication
(10) Pub. No.: US 2022/0190504 A1
(43) Pub. Date: Jun. 16, 2022

(54) CONNECTOR, CONNECTION APPARATUS AND CONNECTION METHOD

(71) Applicant: Panasonic Intellectual Property Management Co., Ltd., Osaka (JP)

(72) Inventor: Yosuke SAKAI, Mie (JP)

(21) Appl. No.: 17/602,548

(22) PCT Filed: Mar. 19, 2020
(86) PCT No.: PCT/JP2020/012188

§ 371 Date: Oct. 8, 2021

(30) Foreign Application Priority Data
Apr. 10, 2019 (JP) 2019-075150
Feb. 5, 2020 (JP) 2020-018307

(51) Int. Cl. H01R 13/24; H01R 12/57; H01R 12/71; H01R 12/73; H01R 12/91; H01R 13/20

(52) U.S. Cl. CPC H01R 13/2407; H01R 12/57; H01R 13/20; H01R 12/73; H01R 12/91; H01R 12/716

(57) ABSTRACT

A connector is configured to be fitted to a mating connector in a first-axis direction. The connector includes a stationary housing, a movable housing, and a contact. The movable housing is movable relative to the stationary housing. The contact has electric conductivity. The contact includes a first held part, a second held part, and an elastic part. The first held part is held by the stationary housing. The second held part is held by the movable housing. The elastic part has elasticity, and connects between the first held part and the second held part. The elastic part includes an extension part. The extension part extends in a second-axis direction intersecting with a first-axis direction from at least one of the first held part or the second held part.

### TECHNICAL FIELD

The present disclosure generally relates to connectors, connection apparatuses, and connection methods, and more specifically, to a connector that includes a contact having electric conductivity and is configured to be fitted to a mating connector, a connection apparatus including the connector, and a connection method of the connection apparatus including the connector and the mating connector configured to be fitted to each other.

### BACKGROUND ART

Patent Literature 1 discloses a connector to be fitted to a mating connection member (mating connector). The connector described in the Patent Literature 1 is so-called a floating connector, and includes a stationary housing, a movable housing, and a plurality of terminals (contacts). Each of the plurality of terminals includes an elastic part having an N-shape. Since the elastic part has an N-shape, it is possible to ensure the length of the elastic part while providing elasticity to the elastic part.

However, according to the connector described in the Patent Literature 1, further ensuring the elasticity of the contact requires an increase in the size of the N-shaped elastic part of the contact. This requires the increase in the size of the contact, which causes the increase in the size of the connector.

### CITATION LIST

### Patent Literature

Patent Literature 1: JP2017-188246A

### SUMMARY OF INVENTION

In view of the above issues, an object of the present disclosure is to provide a connector, a connection apparatus, and a connection method, capable of reducing sizes of the contact and the connector with the elasticity of the contact ensured.

A connector according to an aspect of the present disclosure is configured to be fitted to a mating connector in a first-axis direction. The connector includes a stationary housing, a movable housing, and a contact. The movable housing is movable relative to the stationary housing. The contact has electric conductivity. The contact includes a first held part, a second held part, and an elastic part. The first held part is held by the stationary housing. The second held part is held by the movable housing. The elastic part has elasticity and connects between the first held part and the second held part. The elastic part includes an extension part. The extension part extends in a second-axis direction intersecting with the first-axis direction from at least one of the first held part or the second held part.

A connection apparatus according to another aspect of the present disclosure includes the connector and the mating connector.

A connection method according to yet another aspect of the present disclosure is a connection method of a connection apparatus including a connector and a mating connector configured to be fitted to each other in a first-axis direction. The connector includes a stationary housing, a movable housing, and a contact. The movable housing is movable relative to the stationary housing. The contact has electric conductivity. The contact includes a first held part, a second held part, and an elastic part. The first held part is held by the stationary housing. The second held part is held by the movable housing. The elastic part has elasticity and connects between the first held part and the second held part. The connection method includes a first step, a second step, a third step, a fourth step, and a fifth step. The first step includes preparing the connector mounted on a first substrate and the mating connector mounted on a second substrate. The second step includes bringing, from a state where the connector and the mating connector are out of contact with each other, the mating connector into contact with the connector. The third step includes, after the second step of bringing the mating connector into contact with the connector, applying a load to at least one of the connector or the mating connector while keeping a place of point in contact between the connector and the mating connector to change a relative position of the mating connector to the connector until the movable housing comes into contact with the first substrate. The fourth step includes applying a load to at least one of the connector or the mating connector to make the connector and the mating connector fit to each other. The fifth step includes removing the load from the connector and the mating connector.

### BRIEF DESCRIPTION OF DRAWINGS

FIG. 1 is a perspective view of a connection apparatus according to an embodiment;

FIG. 2 is a perspective view of a connector according to the embodiment;

FIG. 3 is an exploded perspective view of the connector according to the embodiment;

FIG. 4A is a perspective view of a contact as seen from an outer side according to the embodiment, FIG. 4B is a perspective view of the contact as seen from an inner side according to the embodiment, and FIG. 4C is a side view of the contact according to the embodiment;

FIG. 5 is a perspective view of a movable block according to the embodiment;

FIG. 6 is a perspective view of a stationary housing according to the embodiment;

FIG. 7 is a sectional view of the connector according to the embodiment;

FIG. 8 is a sectional view of a main part of the connector according to the embodiment;

FIG. 9 is a sectional view of the connector in a state where a movable housing is positioned at a normal position according to the embodiment;

FIG. 10 is a sectional view of the connector in a state where the movable housing moves laterally downward according to the embodiment;

FIG. 11 is a sectional view of the connector in a state where the movable housing moves laterally upward according to the embodiment;

FIG. 12 is a perspective view of the connection apparatus mounted on a substrate according to the embodiment;

FIG. 13 is a sectional view of the connection apparatus where the connector and a mating connector are in a facing state according to the embodiment;

FIG. 14 is a sectional view of the connection apparatus where the connector and the mating connector are in a first contact state according to the embodiment;

FIG. 15 is a sectional view of the connection apparatus where the connector and the mating connector are in a second contact state according to the embodiment;

FIG. 16 is a sectional view of the connection apparatus where the connector and the mating connector are in a fitted state according to the embodiment;

FIG. 17 is a sectional view of the connection apparatus where the connector and the mating connector are in a fitting completion state according to the embodiment;

FIG. 18A is a perspective view of a contact as seen from an outer side according to a first variation of the embodiment, FIG. 18B is a perspective view of the contact as seen from an inner side according to the first variation, and FIG. 18C is a side view of the contact according to the first variation;

FIG. 19A is a perspective view of a contact as seen from an outer side according to a second variation of the embodiment, FIG. 19B is a perspective view of the contact as seen from an inner side according to the second variation, and FIG. 19C is a side view of the contact according to the second variation;

FIG. 20A is a perspective view of a contact as seen from an outer side according to a third variation of the embodiment, FIG. 20B is a perspective view of the contact as seen from an inner side according to the third variation, and FIG. 20C is a side view of the contact according to the third variation;

FIG. 21A is a perspective view of a contact as seen from an outer side according to a fourth variation of the embodiment, FIG. 21B is a perspective view of the contact as seen from an inner side according to the fourth variation, and FIG. 21C is a side view of the contact according to the fourth variation; and

FIG. 22A is a perspective view of a contact as seen from an outer side according to a fifth variation of the embodiment, FIG. 22B is a perspective view of the contact as seen from an inner side according to the fifth variation, and FIG. 22C is a side view of the contact according to the fifth variation.

### DESCRIPTION OF EMBODIMENTS

A connector and a connection apparatus (connector assembly) according to an embodiment will be explained with reference to drawings. Figures referred to in the following embodiment and the like are schematic, and the ratio of the dimensions including thicknesses, of respective constituent elements illustrated on the drawings does not always reflect their actual dimensional ratio.

### Embodiment

(1) Connection Apparatus (Connector Assembly)

It will be described a configuration of a connection apparatus 1 according to the present embodiment with reference to the drawings.

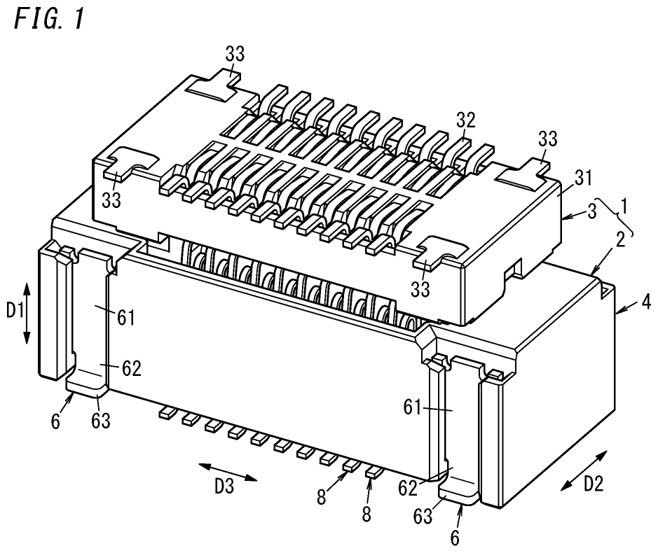

As shown in FIG. 1, the connection apparatus 1 according to the embodiment includes a connector 2 and a mating connector 3.

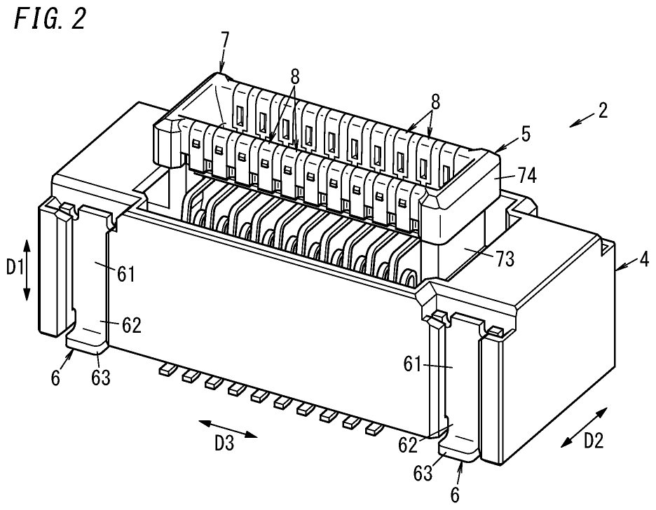

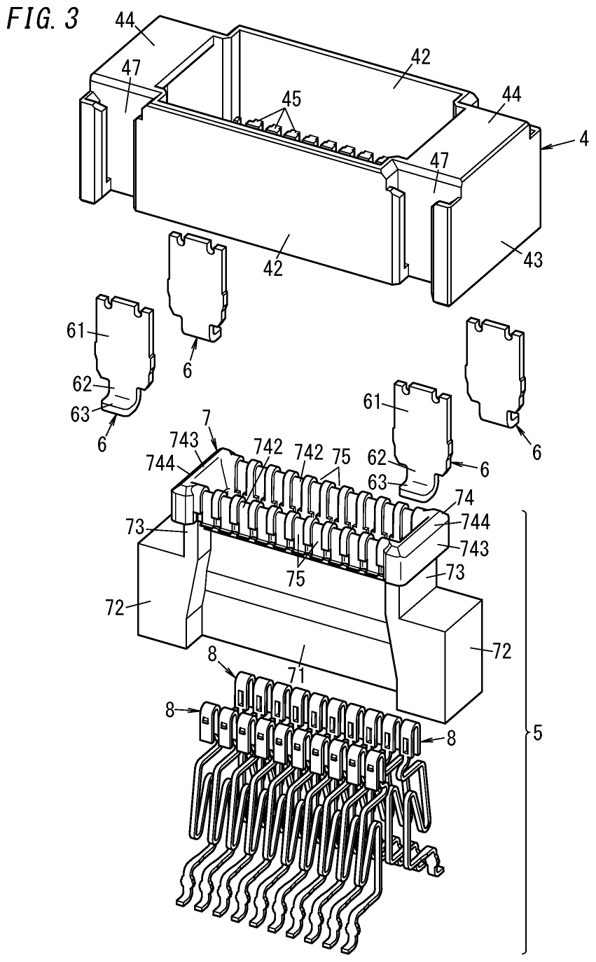

As shown in FIG. 2 and FIG. 3, the connector 2 includes a stationary housing 4, a movable block 5, and a plurality of (four, in the illustrated example) retainer metal fittings 6. The connector 2 is configured to be fitted to the mating connector 3 (see FIG. 1) in a first-axis direction D1.

The connection apparatus 1 according to the embodiment is adapted for use in a connection between two substrates (between a first substrate 91 and a second substrate 92), for example. The connector 2 according to the embodiment has a structure for absorbing the displacement when it is fitted to the mating connector 3, and is, so-called a floating connector.

(2) Components of Connector

Components of the connector 2 according to the embodiment are explained hereinbelow with reference to the drawings.

(2.1) Stationary Housing

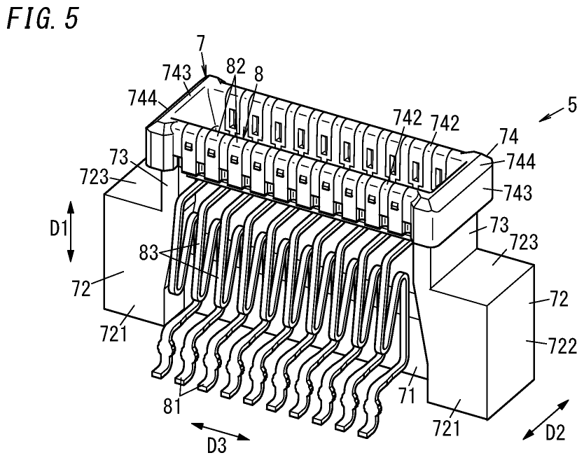

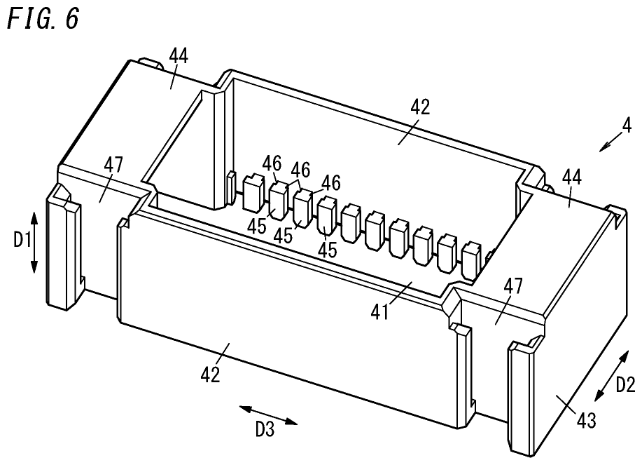

As shown in FIG. 6, the stationary housing 4 is a resin molded article having a frame shape, and has a space 41 in the inside, for example. At least part of the movable block 5 (see FIG. 5) is located in the space 41. The stationary housing 4 includes two first side parts 42, two second side parts 43, and two upper parts 44. The two first side parts 42 face each other in a second-axis direction D2 via the space 41. The two second side parts 43 face each other in a third-axis direction D3 via the space 41. Each of the upper parts 44 is provided at a corresponding end in the third-axis direction D3 of each of the two first side parts 42 to connect upper ends of the two first side parts 42. In the embodiment, the second-axis direction D2 is orthogonal to the first-axis direction D1. The third-axis direction D3 is orthogonal to each of the first-axis direction D1 and the second-axis direction D2.

The stationary housing 4 includes a plurality of protrusions 45 provided to each of the two first side parts 42 so as to be arranged side by side along the longitudinal direction of the stationary housing 4 (third-axis direction D3). Each protrusion 45 is provided with two grooves 46 at both ends in a direction (third-axis direction D3) along which the plurality of protrusions 45 are arranged side by side. Each protrusion 45 has a T-shape as seen in the first-axis direction D1.

(2.2) Movable Block

As shown in FIG. 3, the movable block 5 includes a movable housing 7 and a plurality of contacts 8.

(2.3) Movable Housing

As shown in FIG. 3 and FIG. 5, the movable housing 7 is a resin molded article, for example. The movable housing 7 is a separate member separate from the stationary housing 4, and is movable relative to the stationary housing 4. The movable housing 7 includes a base part 71 having a plate-shape, two projected parts 72, two side wall parts 73, and a connection part 74. The base part 71, the two projected parts 72, the two side wall parts 73 and the connection part 74 are formed integrally by a resin molding, for example.

The base part 71 is provided to extend along the first-axis direction D1 and the third-axis direction D3. The two projected parts 72 are provided at both ends in the third-axis direction D3 of the base part 71, respectively. Each projected part 72 includes two first side parts 721, a second side part 722, and an upper part 723. The two first side parts 721 face each other in the second-axis direction D2. The second side part 722 connects between side ends of the two first side parts 721. The upper part 723 connects between upper ends of the two first side parts 721. The two side wall parts 73 are located at both ends in the third-axis direction D3 of the base part 71 to be on the upper side of the projected parts 72, respectively.

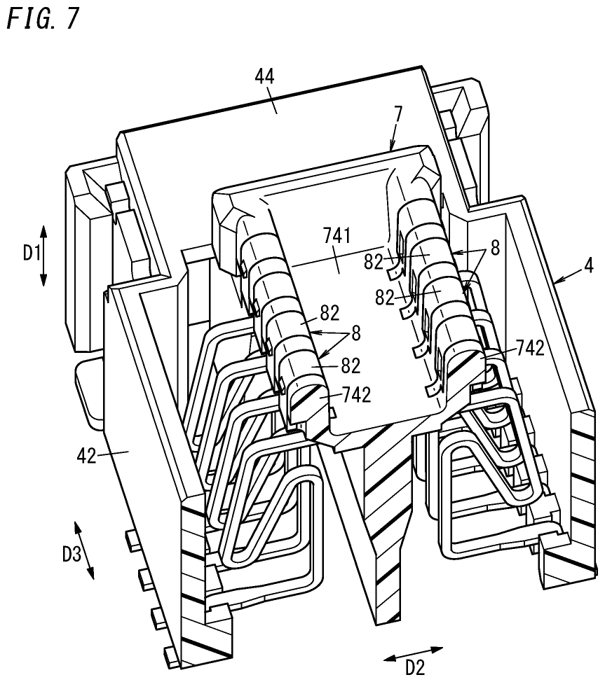

The connection part 74 is provided at an upper end in the first-axis direction D1 of the base part 71. The connection part 74 is configured to be connected to the mating connector 3 when the connector 2 (see FIG. 1) and the mating connector 3 (see FIG. 1) are fitted to each other. The connection part 74 includes a flat part 741 (see FIG. 7), two protruded parts 742, and two protruded parts 743.

The flat part 741 is provided at an upper end in the first-axis direction D1 of the base part 71. The flat part 741 has the normal direction aligned with the first-axis direction D1. The two protruded parts 742 face each other in the second-axis direction D2. The two protruded parts 742 protrude in the first-axis direction D1 from both ends in the second-axis direction D2 of the flat part 741, respectively. Each protruded part 742 is provided with a plurality of grooves 75. The plurality of grooves 75 are arranged side by side along the third-axis direction D3. The plurality of grooves 75 correspond to the plurality of contacts 8. The two protruded parts 743 face each other in the third-axis direction D3. The two protruded parts 743 protrude in the first-axis direction D1 from both ends in the third-axis direction D3 of the flat part 741, respectively. Each protruded part 743 has an inclined surface 744 around the upper end thereof. This can guide the mating connector 3 when the connector 2 (see FIG. 1) is fitted the mating connector 3 (see FIG. 1).

(2.4) Contact

Each of the plurality of contacts 8 has the electric conductivity. As shown in FIG. 3 and FIG. 5, the plurality of contacts 8 are arranged side by side along the longitudinal direction of the movable housing 7 (third-axis direction D3). Specifically, the plurality of contacts 8 are arranged in two rows along the longitudinal direction of the movable housing 7. Examples of the contact 8 includes cupper, copper alloy, and the like.

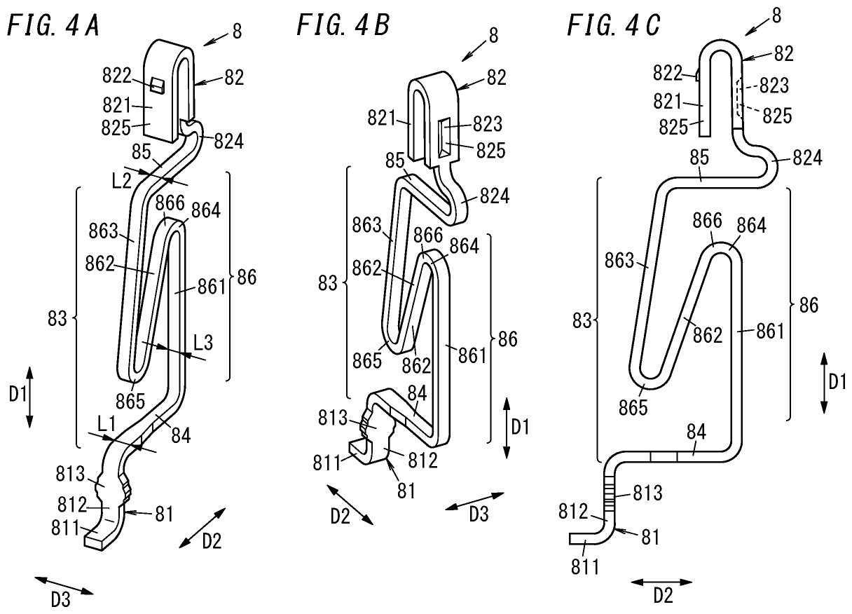

As shown in FIG. 4A to FIG. 4C, each contact 8 includes a first held part 81, a second held part 82, and an elastic part 83. The first held part 81, the second held part 82, and the elastic part 83 are formed integrally.

(2.4.1) First Held Part, Second Held Part

As shown in FIG. 4A to FIG. 4C, the first held part 81 includes a first piece 811 having a plate-shape, and a second piece 812 having a plate shape and protruding in the first-axis direction D1 from the first piece 811. The first piece 811 and the second piece 812 are formed integrally. The second piece 812 includes a wide part 813 having the width greater than the width of a remaining part of the second piece 812. The first held part 81 is held by the stationary housing 4 (see FIG. 7).

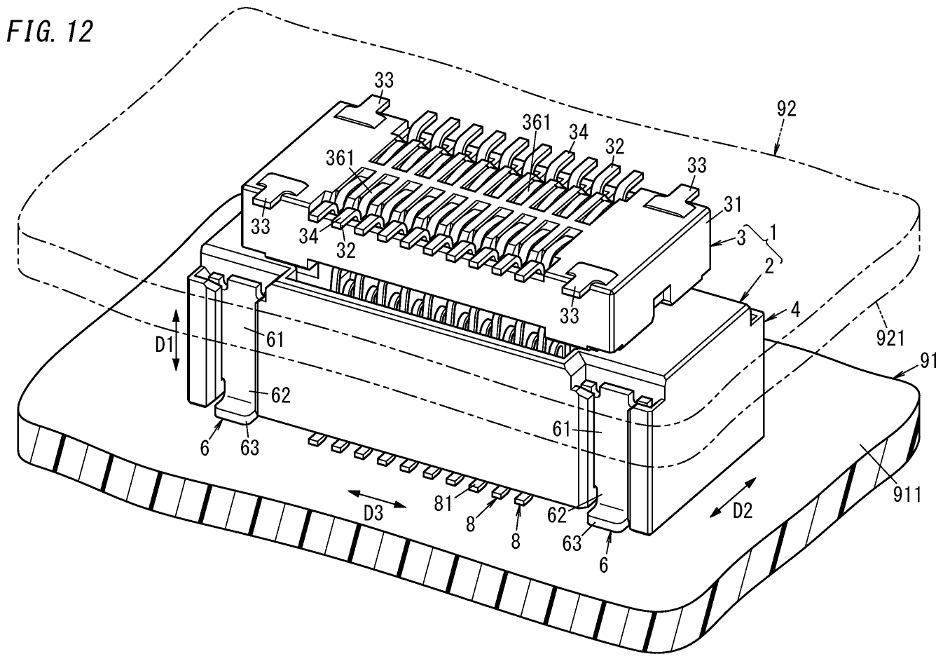

The wider width of the first piece 811 can facilitate the work for soldering the first piece 811 to the first substrate 91 (see FIG. 12). The wider width of the second piece 812 can facilitate the work for press-fitting the second piece 812 to the stationary housing 4. For these(this) reason(s), the first held part 81 has a greater width than the elastic part 83.

The length of the first held part 81, or the length of the second piece 812 may be shortened as much as possible, in order to increase the length in the first-axis direction D1 of the elastic part 83 without increasing the length in the first-axis direction D1 of the contact 8.

As shown in FIG. 4A to FIG. 4C, the second held part 82 includes a base piece 821 having a U-shape as seen in the third-axis direction D3, a protrusion 822 protruding from the base piece 821, and a recess 823 formed in the base piece 821. The protrusion 822 is formed of a part of the base piece 821 partially pressed out. The recess 823 is formed by partially depressing the base piece 821. In some examples, the recess 823 may be formed by partially cutting away the base piece 821 or by partially crushing the base piece 821. The second held part 82 is held by the movable housing 7 (see FIG. 5 and FIG. 7).

The second held part 82 includes a plurality of (two, in the illustrated example) contacting parts 825. Each contacting part 825 is configured to be in contact with the mating connector 3 when the connector 2 is fitted to the mating connector 3. The number of contacting parts 825 provided to the second held part 82 and configured to be in contact with the mating connector 3 is not limited to two, but may be one or three or more.

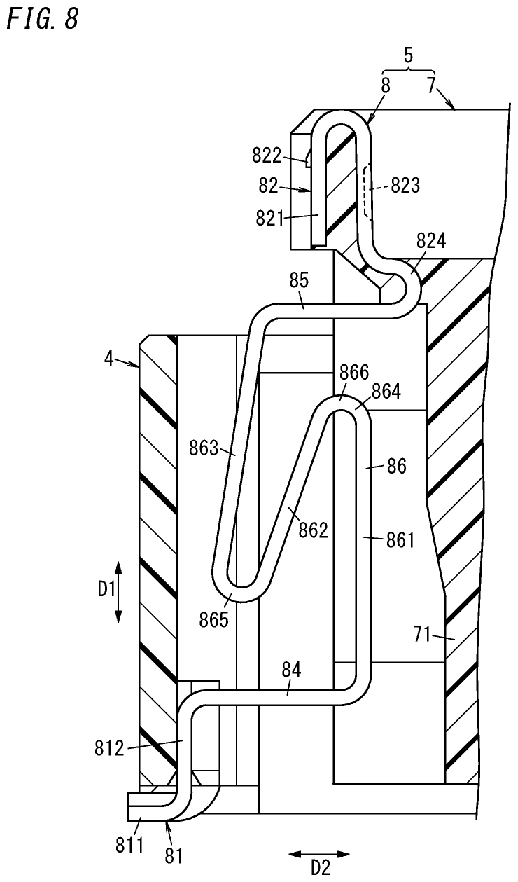

The second held part 82 includes a folded part 824. The folded part 824 is formed at a part, connected to a second extension part 85 described later, of the second held part 82. The folded part 824 has a curved shaped as seen in the third-axis direction D3. The folded part 824 protrudes in the second-axis direction D2. Specifically, the folded part 824 protrudes toward a center of the connector 2 in the second-axis direction D2 in a state where the contact 8 is mounted on the movable housing 7, as shown in FIG. 8.

The folded part 824 provided to the second held part 82 as described above makes it possible to readily ensure the length of the second held part 82, which can increase the elasticity in the first-axis direction D1 of the second held part 82.

It is not limited that only the second held part 82 includes the folded part 824. Alternatively, only the first held part 81 may include a folded part, or both the first held part 81 and the second held part 82 may include respective folded parts. In short, at least one of the first held part 81 or the second held part 82 may include a folded part. Such a folded part(s) makes it possible to readily ensure the length of a held part (first held part 81, second held part 82), which can increase the elasticity in the first-axis direction D1 of the held part.

(2.4.2) Elastic Part

The elastic part 83 has elasticity. As shown in FIG. 4A to FIG. 4C, the elastic part 83 connects between the first held part 81 and the second held part 82. The elastic part 83 includes a first extension part 84 (extension part), the second extension part 85 (extension part), and an intermediate part 86.

(2.4.3) First Extension Part, Second Extension Part

As shown in FIG. 4A to FIG. 4C, the first extension part 84 extends in the second-axis direction D2 from the first held part 81. Specifically, the first extension part 84 extends in the second-axis direction D2 from the first held part 81 to be provided between the intermediate part 86 and the first held part 81. The second-axis direction D2 intersects with (is orthogonal to, in the present embodiment) the first-axis direction D1.

Such the first extension part 84 extending in the second-axis direction D2 orthogonal to the first-axis direction D1 in which the connector 2 and the mating connector 3 are fitted to each other can increase the elasticity in the first-axis direction D1 of the contact 8, namely can increase the mobility in the first-axis direction D1 of the contact 8.

As shown in FIG. 4A to FIG. 4C, the second extension part 85 extends in the second-axis direction D2 from the second held part 82. Specifically, the second extension part 85 extends in the second-axis direction D2 from the second held part 82 to be provided between the intermediate part 86 and the second held part 82.

Such the second extension part 85 extending in the second-axis direction D2 orthogonal to the first-axis direction D1 in which the connector 2 and the mating connector 3 are fitted to each other can increase the elasticity in the first-axis direction D1 of the contact 8, namely can increase the mobility in the first-axis direction D1 of the contact 8.

In the second-axis direction D2, a direction in which the first extension part 84 protrudes from the first held part 81 and a direction in which the second extension part 85 protrudes from the second held part 82 are opposite to each other. As shown in FIG. 4C, the first extension part 84 protruded rightward from the first held part 81, while the second extension part 85 protrudes leftward from the second held part 82.

(2.4.4) Intermediate Part

As shown in FIG. 4A to FIG. 4C, the intermediate part 86 connects between a protruding end of the first extension part 84 and a protruding end of the second extension part 85 so as to reverse an extending direction. Specifically, the intermediate part 86 includes an inside part 861, a middle part 862, and an outside part 863. The intermediate part 86 further includes a pair of curved parts 864, 865. The intermediate part 86 has an N-shape and is flexible in the second-axis direction D2 intersecting with the first-axis direction D1. The “N-shape” used herein indicates a shape which is formed of two pieces (inside part 861 and outside part 863) that extend in one direction (e.g., first-axis direction D1) and one piece (middle part 862) that is positioned between the two pieces and connects between opposite ends in the longitudinal directions of the two pieces. The intermediate part 86 is located between the first extension part 84 and the second extension part 85 in the first-axis direction D1. The intermediate part 86 connects between the ends of the first extension part 84 and second extension part 85 so as to reverse an extending direction.

The inside part 861 extends in the first-axis direction D1 from the first extension part 84. Specifically, the inside part 861 extends in the first-axis direction D1 from an inner end of the first extension part 84 toward the second held part 82 so that the inside part 861 is substantially orthogonal to the first extension part 84.

The middle part 862 extends in a direction intersecting with the first-axis direction D1. The middle part 862 is inclined. Specifically, the middle part 862 is connected to the inside part 861 via the curved part 864, and is connected to the outside part 863 via the curved part 865. In the first-axis direction D1, the middle part 862 is provided to be located on an outer side (approaches the outside part 863) as going toward the first held part 81 from a side of the second held part 82.

The outside part 863 extends in a direction nearly parallel to the first-axis direction D1 from the second extension part 85. Specifically, the outside part 863 extends from an outer end of the second extension part 85 toward the first held part 81 so as to form a nearly right angle with the second extension part 85. The outside part 863 is provided to be located on the outer side as going away from the second extension part 85. As shown in FIG. 8, the intermediate part 86 includes a part facing the stationary housing 4, and a distance between the part facing the stationary housing 4 of the intermediate part 86 and the stationary housing 4 decreases as going away from the mating connector 3 in the first-axis direction D1.

As shown in FIG. 4A to FIG. 4C, the curved part 864 is provided between the inside part 861 and the middle part 862. The curved part 865 is provided between the middle part 862 and the outside part 863. The pair of curved parts 864, 865 are convex toward opposite directions to each other. Specifically, the pair of curved parts 864, 865 are convex toward opposite directions along the first-axis direction D1. When the first-axis direction D1 is defined to be aligned with the upward-downward direction of FIG. 4C, the curved part 864 is convex upward, while the curved part 865 is convex downward.

The intermediate part 86 having an N-shape as described above can increase the elasticity in the second-axis direction D2 of the contact 8.

As described above, the outside part 863 is provided to be located on the outer side as going away from the second extension part 85. That is, the outside part 863 is inclined. This can allow the contact 8 less likely to come in contact with the stationary housing 4 (FIG. 8) when the contact 8 is deformed.

The first extension part 84 and the second extension part 85 are arranged along the first-axis direction D1. Specifically, the first extension part 84 and the second extension part 85 are parallel to each other and along the second-axis direction D2. This can increase the elasticity in the first-axis direction D1 of the contact 8. For example, the contact 8 can absorb a force acting on the contact 8 along the first-axis direction D1.

The intermediate part 86 overlaps the first extension part 84 as seen in the first-axis direction D1. At least part of the intermediate part 86 overlaps the second extension part 85 as seen in the first-axis direction D1. In short, at least part of the intermediate part 86 overlaps the extension part (first extension part 84, second extension part 85) as seen in the first-axis direction D1. Specifically, each of the inside part 861 and the middle part 862 of the intermediate part 86 overlap both the first extension part 84 and the second extension part 85 as seen in the first-axis direction D1. Meanwhile, the outside part 863 overlaps the first extension part 84 but does not overlap the second extension part 85 as seen in the first-axis direction D1.

As shown in FIG. 8, the intermediate part 86 has a vertex part 866 that overlaps the movable housing 7 as seen in the first-axis direction D1. The vertex part 866 is a part of the curved part 864 provided between the inside part 861 and the middle part 862. The vertex part 866 defines a vertex of the curved part 864. The vertex part 866 is behind the movable housing 7 in a state where the contact 8 is mounted on the movable housing 7. The “vertex part” used herein indicates a connection portion between: an inside piece among two pieces (inside part 861 and outside part 863) extending in one direction (e.g., first-axis direction D1); and a piece (middle part 862) that connects between the two pieces.

Such a structure where the vertex part 866 of the intermediate part 86 overlaps the movable housing 7 can reduce the width in the second-axis direction D2 of the connector 2, compared to a structure where a vertex part of an intermediate part does not overlap a movable housing. Accordingly, the size of the connector 2 can be reduced.

As shown in FIG. 4A, a part (first extension part 84), in proximity to the first held part 81, of the elastic part 83 has the width L1 greater than the width of the remaining part of the elastic part 83 (e.g., the width L2 of the second extension part 85, the width L3 of the intermediate part 86). This can increase the strength of a part (first extension part 84) around the first held part 81 which is to be held with the press-fitting. Meanwhile, a part other than the part subject to be press-fitted has a small width, which contributes to ensure the elasticity. That is, it is possible to increase the strength of the part around the part subject to be press-fitted while ensuring the elasticity.

Apart (e.g., second extension part 85), in proximity to the second held part 82, of the elastic part 83 may have the width greater than the width of the remaining part of the elastic part 83 (e.g., the width of the first extension part 84, the width of the intermediate part 86). In short, a width of the elastic part 83 at either or both of a part in proximity to the first held part 81 and a part in proximity to the second held part 82 may be greater than a width of a remaining part of the elastic part 83. This can increase the strength of a part (first extension part 84, second extension part 85) around the held part (first held part 81, second held part 82) which is to be held with the press-fitting.

As shown in FIG. 4A to FIG. 4C, the elastic part 83 has the width smaller than each of the width of the first held part 81 and the width of the second held part 82. As a result, the elastic part 83 may be readily deformed compared to the first held part 81 and the second held part 82 are. That is, the small width of the elastic part 83 allows the elastic part 83 to be deformed with a small load. The load required to have the elastic part 83 elastically deformed may be adjusted by changing the width of the elastic part 83.

(2.4.5) Arrangement of Contacts

As shown in FIG. 7, the plurality of contacts 8 are arranged along the longitudinal direction of each of the stationary housing 4 and the movable housing 7 (third-axis direction D3).

Focusing on any adjacent two contacts 8 of the plurality of contacts 8, the stationary housing 4 is present between the first held parts 81 thereof, and the movable housing 7 is present between the second held parts 82 thereof. In other words, the stationary housing 4 is present between adjacent two first held parts 81, and the movable housing 7 is present between adjacent two second held parts 82.

Meanwhile, focusing on the adjacent two contacts 8 of the plurality of contacts 8, none of the stationary housing 4 and the movable housing 7 is present between the elastic parts 83 thereof. That is to say, no resin molded part is present between adjacent two intermediate parts 86, but an empty space exists therebetween. This can allow the region between the adjacent two contacts 8 to have a low dielectric property to enhance the transmission property.

It may be noted that, as to adjacent two contacts 8, both conditions are not necessarily satisfied simultaneously that the stationary housing 4 is present between the first held parts 81 and that the movable housing 7 is present between the second held parts 82. It may be possible that the stationary housing 4 is present between the first held parts 81 but the movable housing 7 is not present between the second held parts 82. It may also be possible that the stationary housing 4 is not present between the first held parts 81 but the movable housing 7 is present between the second held parts 82. In short, as to the two adjacent two contacts 8 of the plurality of contacts 8, at least one of the stationary housing 4 or the movable housing 7 may be present between the first held parts 81 thereof or between the second held parts 82 thereof.

As described above, the distance between the part (outside part 863) facing the stationary housing 4 of the intermediate part 86 and the stationary housing 4 decreases as going away from the mating connector 3 in the first-axis direction D1 (see FIG. 8).

(2.5) Retainer Metal Fitting

As shown in FIG. 1 to FIG. 3, the plurality of retainer metal fittings 6 are mounted on the stationary housing 4. Each retainer metal fitting 6 includes a base part 61, a first extension part 62, and a second extension part 63. The base part 61, the first extension part 62, and the second extension part 63 are made of a metal plate and are formed integrally. The base part 61 has a plate shape of a substantially rectangle. The first extension part 62 extends in the first-axis direction D1 from a first end (lower end in FIG. 3) of the base part 61. In the third-axis direction D3, the first extension part 62 has the width smaller than the width of the base part 61. The second extension part 63 extends in the second-axis direction D2 from the first extension part 62.

The plurality of retainer metal fittings 6 are mounted on a plurality of corners of the stationary housing 4. Specifically, each retainer metal fitting 6 is mounted on the stationary housing 4 with the base part 61 inserted in a groove 47 of the stationary housing 4.

The plurality of contacts 8 and the plurality of retainer metal fittings 6 are fixed to the first substrate 91 (see FIG. 12). As a result, the connector 2 is held by the first substrate 91.

(3) Behavior of Connector

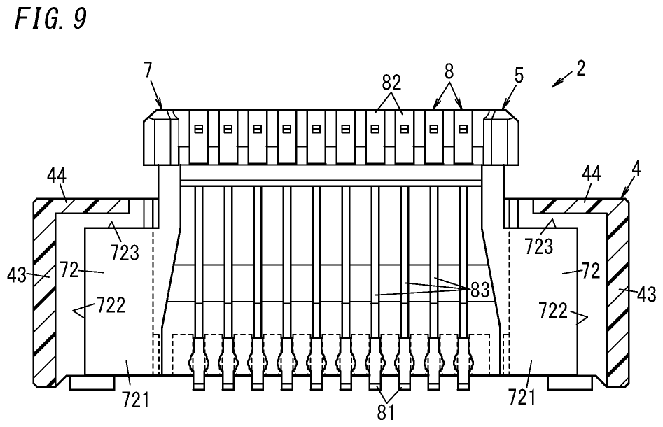

A behavior of the connector 2 according to the embodiment will be explained with reference to FIG. 9 to FIG. 11.

In a normal state shown in FIG. 9, the movable housing 7 floats above a lower surface. In other words, the movable housing 7 is apart from the first substrate 91 (see FIG. 12) on which the stationary housing 4 is mounted. The movable housing 7 is out of contact with the stationary housing 4.

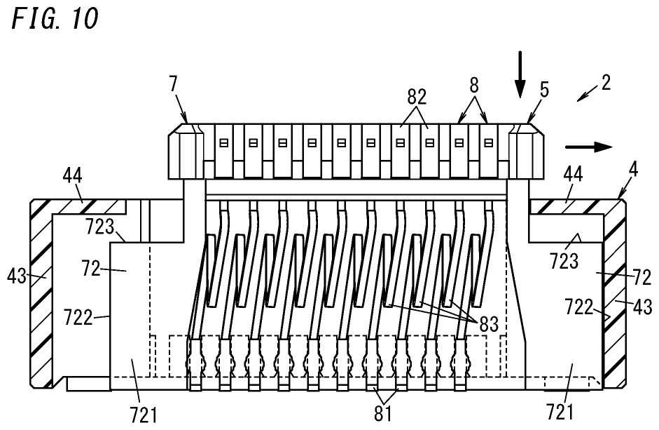

FIG. 10 illustrates the connector 2 in a state where the movable housing 7 is applied with a downward force and a lateral (rightward in FIG. 10) force. With the downward force applied to the movable housing 7, the movable housing 7 is located at a position lower than a position in the normal state. With the lateral force applied thereto, the movable housing 7 is moved rightward and brought into contact with an inner side surface (an inner side surface of the second side part 43) on a right side of the stationary housing 4. In each contact 8, the elastic part 83 is deformed while the first held part 81 is fixed to the stationary housing 4 and the first substrate 91 (see FIG. 12) and the second held part 82 is fixed to the movable housing 7.

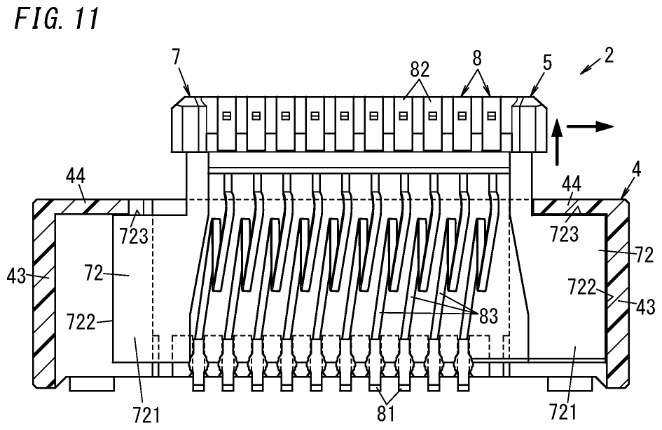

FIG. 11 illustrates the connector 2 in a state where the movable housing 7 is applied with an upward force and a lateral (rightward in FIG. 11) force. With the upward force applied to the movable housing 7, the movable housing 7 is located at a position upper than a position in the normal state. In this example, the movable housing 7 is in contact with an inner side surface on an upper side (an inner side surface of the upper part 44) of the stationary housing 4. With the lateral force applied thereto, the movable housing 7 is moved rightward and brought into contact with an inner side surface (the inner side surface of the second side part 43) on a right side of the stationary housing 4. In each contact 8, the elastic part 83 is deformed while the first held part 81 is fixed to the stationary housing 4 and the first substrate 91 (see FIG. 12) and the second held part 82 is fixed to the movable housing 7.

(4) Mating Connector

Hereinafter, a configuration of the mating connector 3 according to the embodiment is explained with reference to the drawings.

As shown in FIG. 1, the mating connector 3 includes a mating housing 31, a plurality of mating contacts 32, and a plurality of mating retainer metal fittings 33.

(4.1) Mating Housing

The mating housing 31 is a resin molded article having a cuboid shape, for example. The plurality of mating contacts 32 and the plurality of mating retainer metal fitting 33 are mounted on the mating housing 31.

(4.2) Mating Contact

Each of the plurality of mating contacts 32 has the electric conductivity. The plurality of mating contacts 32 correspond one-to-one to the plurality of contacts 8. The plurality of mating contacts 32 are arranged side by side along the longitudinal direction of the mating housing 31 (third-axis direction D3). Specifically, the plurality of mating contacts 32 are arranged in two rows along the longitudinal direction of the mating housing 31. Examples of the mating contact 32 includes cupper, copper alloy, and the like.

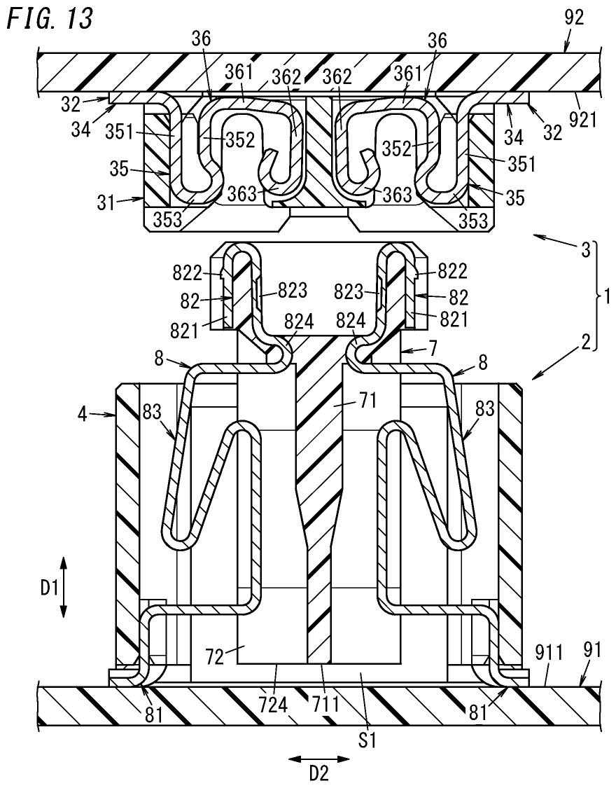

As shown in FIG. 13, each mating contact 32 includes a connection part 34, a first elastic part 35, and a second elastic part 36. The connection part 34, the first elastic part 35, and the second elastic part 36 are formed integrally.

As shown in FIG. 12 and FIG. 13, the connection part 34 is constituted by piece having an elongated plate shape extending in the second-axis direction D2. The connection part 34 is located on an outside of the mating housing 31, and is to be soldered to a principal surface 921 of the second substrate 92.

As shown in FIG. 12 and FIG. 13, the first elastic part 35 includes a first piece 351, a second piece 352, and a first contact part 353. The first piece 351 has an elongated plate shape, and extends in the first-axis direction D1 from an end of the connection part 34. The second piece 352 has an elongated plate shape, and extends in the first-axis direction D1. The second piece 352 faces the first piece 351 in the second-axis direction D2. The first contact part 353 has a circular arc shape as seen in the third-axis direction D3. The first contact part 353 connects between the first piece 351 and the second piece 352.

As shown in FIG. 12 and FIG. 13, the second elastic part 36 includes a third piece 361, a fourth piece 362, and a second contact part 363. The third piece 361 has an elongated plate shape, and extends in the second-axis direction D2 from an end of the second piece 352 of the first elastic part 35. The fourth piece 362 has an elongated plate shape, and extends in the first-axis direction D1 from an end of the third piece 361. The second contact part 363 has a U-shape as seen in the third-axis direction D3, and is connected to an end of the fourth piece 362. The second elastic part 36 may be flexed when the second contact part 363 is applied with a force both in the first-axis direction D1 and the second-axis direction D2. The second contact part 363 of the second elastic part 36 faces the first contact part 353 of the first elastic part 35 in the second-axis direction D2.

(4.3) Mating Retainer Metal Fitting

The plurality of mating retainer metal fittings 33 are mounted on the mating housing 31. Specifically, the plurality of mating retainer metal fittings 33 are provided at a plurality of corners of the mating housing 31.

The plurality of mating contact 32 and the plurality of mating retainer metal fittings 33 are fixed to the second substrate 92 (see FIG. 12). As a result, the mating connector 3 is held by the second substrate 92.

As shown in FIG. 1, the mating connector 3 is fitted to the connector 2 such that the plurality of mating contacts 32 are in contact with corresponding contacts 8.

(5) Connection Method

The connection method of the connector 2 and the mating connector 3 is explained hereinbelow with reference to the drawings. The connection method of the connector 2 and the mating connector 3 includes first to fifth steps.

The first step includes preparing the connector 2 mounted on the first substrate 91 and the mating connector 3 mounted on the second substrate 92, as shown in FIG. 13.

As described above, the connector 2 is mounted on the first substrate 91. Specifically, the connector 2 is a surface mounted component mounted on a principal surface 911 of the first substrate 91. The contacts 8 are soldered to electrical conductors of the first substrate 91 at their first pieces 811 of the first held parts 81, and the retainer metal fittings 6 are soldered to electrical conductors of the first substrate 91 at their second extension parts 63. Accordingly, the connector 2 is fixed to the first substrate 91 with the contacts 8 connected to the electric conductors of the first substrate 91.

As described above, the mating connector 3 is mounted on the second substrate 92. Specifically, the mating connector 3 is a surface mounted component mounted on the principal surface 921 of the second substrate 92. The mating contacts 32 are soldered to electric conductors of the second substrate 92, and the mating retainer metal fittings 33 are soldered to electric conductors of the second substrate 92. Accordingly, the mating connector 3 is fixed to the second substrate 92 with the mating contacts 32 connected to the electric conductors of the second substrate 92. Subsequently, the connector 2 and the mating connector 3 are arranged to face each other in the first-axis direction D1 where the connector 2 is mounted on the first substrate 91 and the mating connector 3 is mounted on the second substrate 92. In the example illustrated in FIG. 13, the first-axis direction D1 is parallel to the upward-downward direction, the connector 2 is located at a lower side and the mating connector 3 is located at an upper side so that the connector 2 and the mating connector 3 face each other.

Hereinafter, the state described above where the connector 2 and the mating connector 3 face while being separated from each other in the first-axis direction D1 is referred to as a “facing state”. In the “facing state”, there is a gap S1 between the movable housing 7 of the connector 2 and the first substrate 91 in the first-axis direction D1. Specifically, the gap S1 is between: a bottom 711 of the base part 71 as well as bottoms 724 of the projected parts 72 of the movable housing 7 of the connector 2; and the principal surface 911 of the first substrate 91. In the “facing state”, the movable housing 7 is apart from the first substrate 91 without in contact with the first substrate 91.

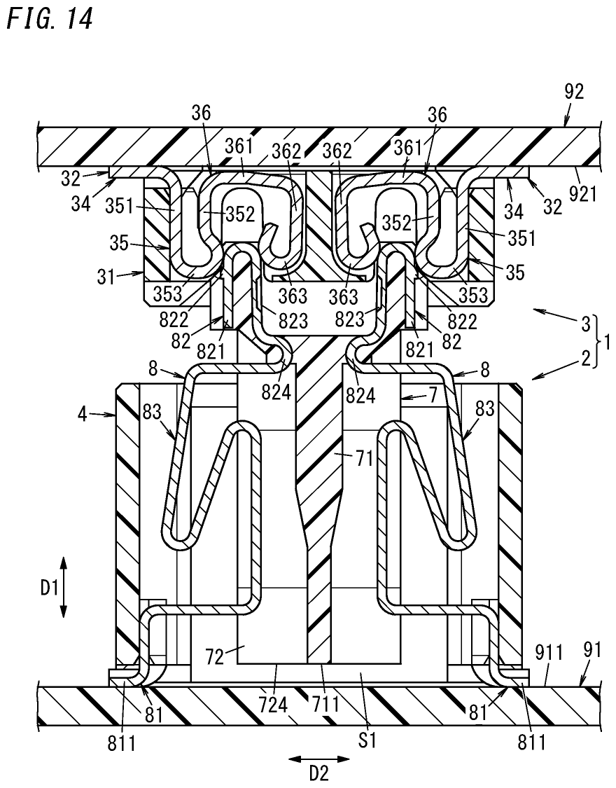

The second step includes bringing, from a state where the connector 2 and the mating connector 3 are out of contact with each other, the mating connector 3 into contact with the connector 2, as shown in FIG. 14. In this step, the contact 8 of the connector 2 is not elastically deformed. The contact 8 of the connector 2 is not applied with a minimum load Fm required to elastically deform the contact 8.

In the example illustrated in FIG. 14, the connector 2 and the mating connector 3 are firstly positioned to face each other with the connector 2 located at the lower side and the mating connector 3 located at the upper side, and then the mating connector 3 is relatively moved toward the connector 2, as a result of which part of the mating connector 3 comes into contact with the second held part 82 at two points with regard to each contact 8 of the connector 2. Specifically, the first contact part 353 of the first elastic part 35 and the second contact part 363 of the second elastic part 36 of the mating contact 32 come into contact with the base piece 821 of the second held part 82 of the contact 8.

Hereinafter, the state described above where the mating connector 3 is in contact with the connector 2 is referred to as a “first contact state”. In the “first contact state”, the contacts 8 of the connector 2 and the mating contacts 32 of the mating connector 3 are in contact with each other, so that the contacts 8 and the mating contacts 32 are electrically connected to each other. However, in the “first contact state”, the connector 2 and the mating connector 3 are mere partially in contact with each other with a load smaller than the minimum load Fm required to deform the contact 8 of the connector 2, and thus are not fitted to each other. That is, the connector 2 and the mating connector 3 in the “first contact state” are not sufficiently fitted (connected) to each other. Thus, there is no guarantee that the electrical connection between the contact 8 of the connector 2 and the mating contact 32 of the mating connector 3 is secured when the load is removed from the mating connector. This means that, when the load is removed, the contact 8 and the mating contact 32 may keep in contact with each other or may be separated from each other.

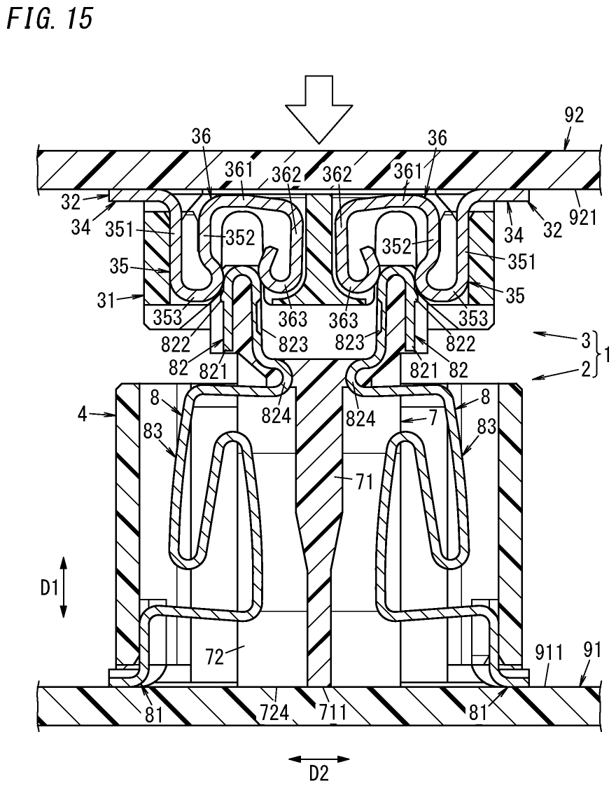

The third step includes changing a relative position of the mating connector 3 to the connector 2 until the movable housing 7 comes into contact with the first substrate 91, as shown in FIG. 15. Specifically, after the second step of bringing the connector 2 into contact with the mating connector 3, a load (indicated by the arrow shown in FIG. 15) is applied to at least one of the connector 2 or the mating connector 3 while keeping a state where the mating connector 3 is in contact with the connector 2, and thereby the relative position of the mating connector 3 to the connector 2 being changed until the movable housing 7 comes into contact with the first substrate 91. This step is performed while keeping a place of the first contact state where the contact 8 of the connector 2 is in contact with the mating contact 32 of the mating connector 3. The feature “keeping a place where the contact 8 of the connector 2 is in contact with the mating contact 32 of the mating connector 3” means that a place in the contact 8 of the connector 2 at which is in contact with the mating contact 32 of the mating connector 3 is kept unchanged.

When the load is applied to the mating connector 3, the load applied to the mating connector 3 causes a force acting on the connector 2 from the mating connector 3 to elastically deform the contact 8 of the connector 2. The elastic part 83 of the contact 8 is elastically deformed so as to move toward the first substrate 91 as a whole. A load Fc required to slide the place of point in contact between the connector 2 and the mating connector 3 from a place of the first contact state toward the first substrate 91 (away from the mating connector 3) is smaller than the minimum load Fm required to elastically deform the contact 8 of the connector 2.

As in the example illustrated in FIG. 15, from the “first contact state” illustrated in FIG. 14, a load (indicated by the arrow shown in FIG. 15) toward the connector 2 (downward load) is applied to the mating connector 3. According to the load applied, the mating connector 3 is pressed downward until the bottom 711 of the base part 71 as well as the bottoms 724 of the projected parts 72 of the movable housing 7 come into contact with the principal surface 911 of the first substrate 91.

When the load is applied to the mating connector 3, the load applied to the mating connector 3 causes a force acting on the connector 2 from the mating connector 3 to elastically deform the contact 8 of the connector 2. The elastic part 83 of the contact 8 is elastically deformed so as to move toward the first substrate 91 as a whole. This elastic deformation of the contacts 8 allows the movable housing 7 to move downward. That is, this can change the relative position of the movable housing 7 to the stationary housing 4.

Hereinafter, the state described above where the mating connector 3 is pressed to the position where the movable housing 7 is in contact with the first substrate 91 is referred to as a “second contact state”. In the “second contact state”, the contacts 8 of the connector 2 and the mating contacts 32 of the mating connector 3 are in contact with each other, so that the contacts 8 and the mating contacts 32 are electrically connected to each other. However, in the “second contact state”, the connector 2 and the mating connector 3 are mere partially in contact with each other with the load, and thus are not fitted to each other. That is, the connector 2 and the mating connector 3 in the “second contact state” are not sufficiently fitted (connected) to each other. Thus, there is no guarantee that the electrical connection between the contact 8 of the connector 2 and the mating contact 32 of the mating connector 3 is secured when the load is removed from the mating connector. This means that, when the load is removed, the relative position of the mating connector 3 to the connector 2 may be changed, and the contact 8 and the mating contact 32 may keep in contact with each other or may be separated from each other.

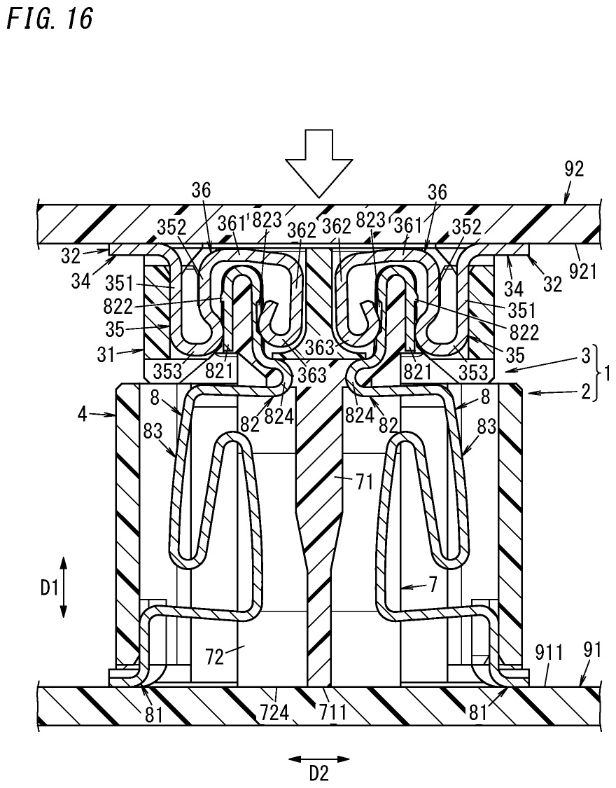

The fourth step includes fitting the connector 2 and the mating connector 3 to each other, as shown in FIG. 16. Specifically, a load (indicated by the arrow shown in FIG. 16) is applied to at least one of the connector 2 or the mating connector 3 while the movable housing 7 is in contact with the first substrate 91. In the example illustrated in FIG. 16, the load is applied to the mating connector 3 toward the connector 2. In this step, the load applied to the mating connector 3 causes a force acting on the movable housing 7, but the movable housing 7 cannot move anymore toward the first substrate 91 since the movable housing 7 has already been in contact with the first substrate 91. The load applied to the mating connector 3 in a state where the movable housing 7 is in contact with the first substrate 91 can make the connector 2 and the mating connector 3 to be fitted to each other.

As in the example illustrated in FIG. 16, from the “second contact state” illustrated in FIG. 15, a load (indicated by the arrow shown in FIG. 16) toward the connector 2 (downward load) is applied to the mating connector 3. According to the load, the mating connector 3 is pressed downward with the position of the movable housing 7 kept as it is, since the movable housing 7 is in contact with the first substrate 91 and the movement toward the first substrate 91 is restricted. As a result, the connector 2 and the mating connector 3 are fitted to each other.

According to the downward movement of the mating connector 3 caused by the load, the second elastic part 36 of the mating contact 32 of the mating connector 3 comes into contact with the second held part 82 of the contact 8 of the connector 2, which causes the second contact part 363 of the second elastic part 36 to be bent. Further application of a load causes the mating connector 3 to further move downward, and as a result a part of the second contact part 363 of the second elastic part 36 is fitted into the recess 823 of the second held part 82.

Hereinafter, the state described above where the connector 2 and the mating connector 3 are fitted to each other is referred to as a “fitted state”. In the “fitted state”, the connection between the connector 2 and the mating connector 3 is secured. The contacts 8 of the connector 2 and the mating contacts 32 of the mating connector 3 are fitted to each other, which can stabilize the contact between the contact 8 and the mating contact 32 and can stabilize the electrical connection between the contact 8 and the mating contact 32 in the use of the connection apparatus 1.

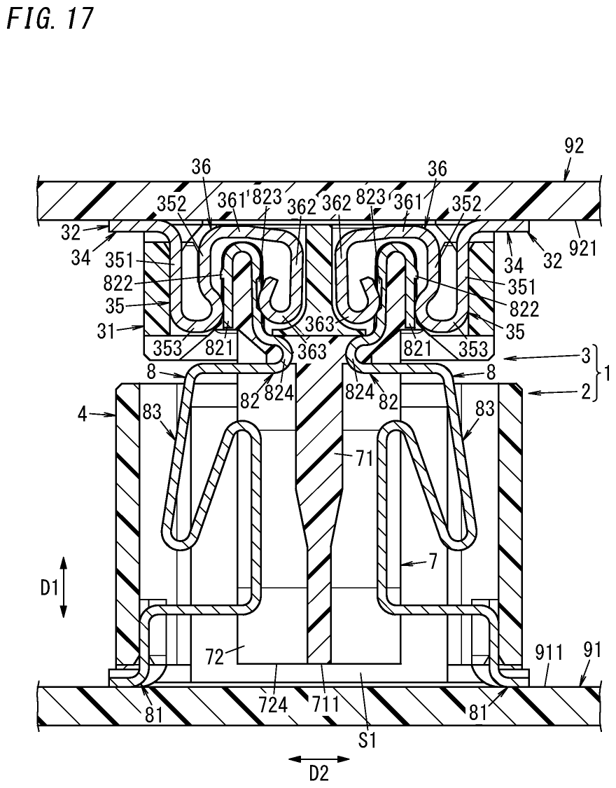

The fifth step includes removing the load from the connector 2 and the mating connector 3, as shown in FIG. 17. When the load is removed from the connector 2 and the mating connector 3, the mating connector 3 moves from a position where the mating connector 3 is pressed inside the connector 2 toward a side away from the connector 2 to reach an initial fitting position. Specifically, when the load is removed, the movable housing 7 returns from a state where the movable housing 7 is in contact with the first substrate 91 to an initial state where the movable housing 7 is apart from the first substrate 91 by the spring force of the contacts 8 of the connector 2. It should be noted that the connector 2 and the mating connector 3 maintain the fitted state after the load is removed from the connector 2 and the mating connector 3. The contacted state between the connector 2 and the mating connector 3 is thus kept without the connector 2 detached from the mating connector 3. Moreover, this can stabilize the electrical connection between the contact 8 and the mating contact 32 in the use of the connection apparatus 1.

In a “fitting completion state” after the fifth step, the connector 2 and the mating connector 3 are fitted and fixed to each other. In this state, it is possible to keep the electrical connection between the contact 8 of the connector 2 and the mating contact 32 of the mating connector 3 and also to reduce a slide movement of the contact 8 of the connector 2 with respect to the mating contact 32 of the mating connector 3 even when the connection apparatus 1 receives a vibration or a load.

The above described first to fifth steps can realize a connection between the connection between the connector 2 and the mating connector 3 with the connector 2 and the mating connector 3 electrically connected with each other, as shown in FIG. 12. As a result, the first substrate 91 and the second substrate 92 can be electrically connected to each other via the connection apparatus 1.

(6) Advantages

In the connector 2 according to the embodiment, the elastic part 83 connecting between the first held part 81 and the second held part 82 includes at least one of the first extension part 84 or the second extension part 85 (extension part) extending from the first held part 81 or the second held part 82. This aspect can reduce the sizes of the contact 8 and the connector 2 with the elasticity of the contact 8 ensured.

In the connector 2 according to the embodiment, there are provided the first extension part 84, the second extension part 85, and the intermediate part 86 having an N-shape. This aspect can increase the elasticity of the contact 8, and can further reduce the sizes of the contact 8 and the connector 2.

In the connector 2 according to the embodiment, the first extension part 84 and the second extension part 85 are arranged in the first-axis direction D1. This aspect can increase the elasticity in the first-axis direction D1 of the contact 8.

In the connector 2 according to the embodiment, the first extension part 84 and the second extension part 85 protrude toward opposite directions to each other, and the intermediate part 86 connects between a protruding end of the first extension part 84 and a protruding end of the second extension part 85 so as to reverse an extending direction. This aspect can further increase the elasticity of the elastic part 83, i.e., the elasticity of the contact 8.

In the connector 2 according to the embodiment, the intermediate part 86 includes at least one curved part 864, 865. This aspect can readily increase the elasticity of the elastic part 83, i.e., the elasticity of the contact 8.

In the connector 2 according to the embodiment, there are provided a plurality of curved parts 864, 865. This aspect can further increase the elasticity of the elastic part 83, i.e., the elasticity of the contact 8.

In the connector 2 according to the embodiment, there are provided a pair of curved parts 864, 865 convex toward opposite directions to each other. This aspect can efficiently increase the elasticity with the small number of curved parts.

In the connector 2 according to the embodiment, the pair of curved parts 864, 865 are convex toward opposite directions along the first-axis direction D1. This aspect can further increase the elasticity in a direction intersecting with the first-axis direction D1.

In the connector 2 according to the embodiment, at least part of the intermediate part 86 overlaps the first extension part 84 and the second extension part 85 (extension part). This aspect can make the contact 8 in a compact size with the elasticity ensured.

In the connector 2 according to the embodiment, the vertex part 866 of the intermediate part 86 overlaps the movable housing 7 as seen in the first-axis direction D1. This aspect can reduce the width in a direction intersecting with the first-axis direction D1 of the connector 2, compared to a structure where a vertex part of an intermediate part does not overlap a movable housing. This aspect thus can reduce the size of the connector 2.

In the connector 2 according to the embodiment, the second held part 82 includes the folded part 824 at a connection part thereof connected to the second extension part 85 (extension part). This aspect makes it possible to readily ensure the length of the second held part 82 (held part), which can increase the elasticity in the first-axis direction D1 of the contact 8.

In the connector 2 according to the embodiment, the width L1 of the elastic part 83 at a part (first extension part 84) in proximity to the first held part 81 is greater than the width L2, L3 of the remaining part of the elastic part 83. This aspect can increase the strength of the part (first extension part 84) around the first held part 81 which is to be held with the press-fitting.

In the connector 2 according to the embodiment, as to two contacts 8 adjacent to each other, at least one of the stationary housing 4 or the movable housing 7 is present between the first held parts 81 or between the second held parts 82. Mean while, none of the stationary housing 4 and the movable housing 7 is present between the elastic parts 83. This aspect can make the region between the adjacent two contacts 8 to have a low dielectric property to enhance the transmission property.

In the connector 2 according to the embodiment, the middle part 862 of the intermediate part 86 extends in a direction intersecting with the first-axis direction D1. This aspect can ensure the elasticity with a simplified structure.

In the connector 2 according to the embodiment, a distance between a part facing the stationary housing 4 of the intermediate part 86 and the stationary housing 4 decreases as going away from the mating connector 3 in the first-axis direction D1. With this aspect, the contact 8 is less likely to come into contact with the stationary housing 4 when the contact 8 is deformed. Thus, a large space can be ensured for the contact 8 to move thereinside.

(7) Variation

Variations of the embodiment are explained hereinbelow.

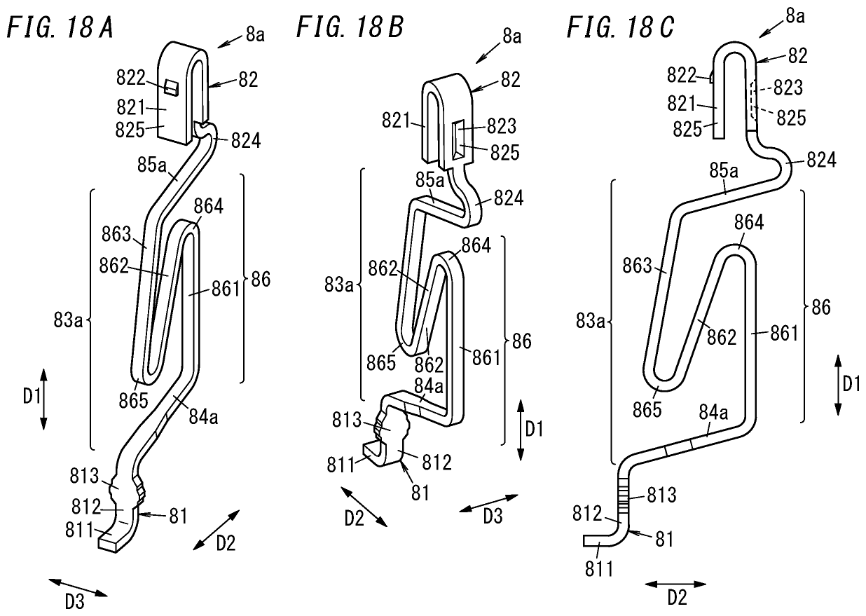

In a first variation of the embodiment, a connector 2 may include a contact 8a as shown in FIG. 18A to FIG. 18C. As with the contacts 8 of the embodiment (see FIG. 2), a plurality of the contacts 8a are arranged side by side along the longitudinal direction of a movable housing 7 (see FIG. 2).

Each contact 8a includes a first held part 81, a second held part 82, and an elastic part 83a. The first held part 81 and the second held part 82 of the first variation are the same as the first held part 81 and the second held part 82 of the embodiment (see FIG. 4A to FIG. 4C).

The elastic part 83a includes a first extension part 84a (extension part), a second extension part 85a (extension part), and an intermediate part 86. The intermediate part 86 of the first variation is the same as the intermediate part 86 of the embodiment (see FIG. 4A to FIG. 4C).

The first extension part 84a extends in a direction intersecting with a first-axis direction D1 from the first held part 81. Specifically, the first extension part 84a extends to approach the second held part 82 as going away from the first held part 81. In FIG. 18C, the first extension part 84a is inclined such that the right end thereof is positioned above the left end thereof.

The second extension part 85a extends in a direction intersecting with the first-axis direction D1 from the second held part 82. Specifically, the second extension part 85a extends to approach the first held part 81 as going away from the second held part 82. In FIG. 18C, the second extension part 85a is inclined such that the left end thereof is positioned below the right end thereof.

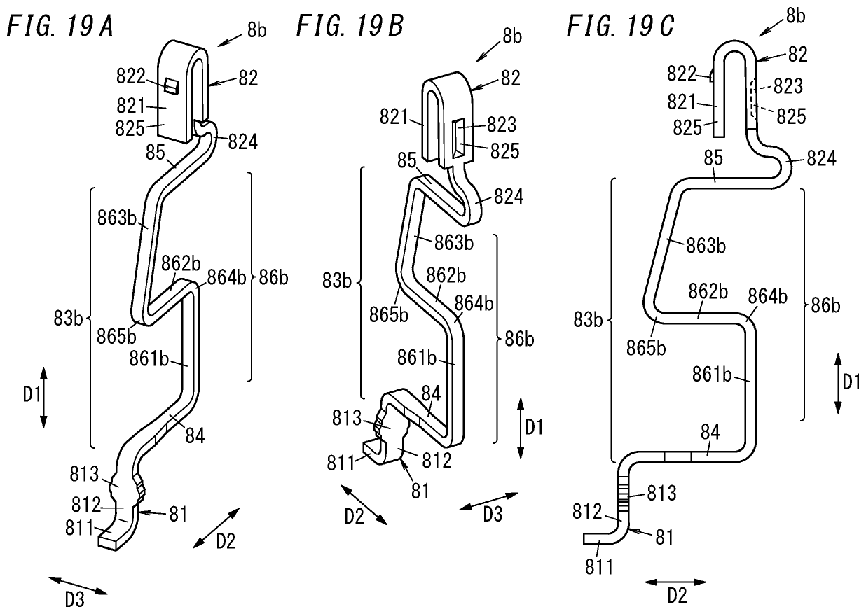

In a second variation of the embodiment, a connector 2 may include a contact 8b as shown in FIG. 19A to FIG. 19C. As with the contacts 8 of the embodiment (see FIG. 2), a plurality of the contacts 8b are arranged side by side along the longitudinal direction of a movable housing 7 (see FIG. 2).

Each contact 8b includes a first held part 81, a second held part 82, and an elastic part 83b. The first held part 81 and the second held part 82 of the second variation are the same as the first held part 81 and the second held part 82 of the embodiment (see FIG. 4A to FIG. 4C).

The elastic part 83b includes a first extension part 84, a second extension part 85, and an intermediate part 86b. The first extension part 84 and the second extension part 85 of the second variation are the same as the first extension part 84 and the second extension part 85 of the embodiment (see FIG. 4A to FIG. 4C).

The intermediate part 86b has an S-shape flexible both in a first-axis direction D1 and a second-axis direction D2. The intermediate part 86b includes an inside part 861b, a middle part 862b, and an outside part 863b. The intermediate part 86b further includes a pair of curved parts 864b, 865b.

The inside part 861b extends in the first-axis direction D1 from the first extension part 84. Specifically, the inside part 861b is orthogonal to the first extension part 84. The inside part 861b is shorter than inside part 861 of the embodiment (see FIG. 4A to FIG. 4C).

The middle part 862b extends in a direction intersecting with the first-axis direction D1. Specifically, the middle part 862b extends in the second-axis direction D2. The middle part 862b is parallel to the first extension part 84 and the second extension part 85.

The outside part 863b extends in a direction nearly parallel to the first-axis direction D1 from the second extension part 85. Specifically, the outside part 863b extends from an outer end of the second extension part 85 toward the first held part 81 so as to form a nearly right angle with the second extension part 85. The outside part 863b is provided to be located on the outer side as going away from the second extension part 85.

The curved part 864b is provided between the inside part 861b and the middle part 862b. The curved part 864b is provided such that the inside part 861b and the middle part 862b form a substantially right angle. The curved part 865b is provided between the middle part 862b and the outside part 863b. The curved part 865b is provided such that the middle part 862b and the outside part 863b form a substantially right angle.

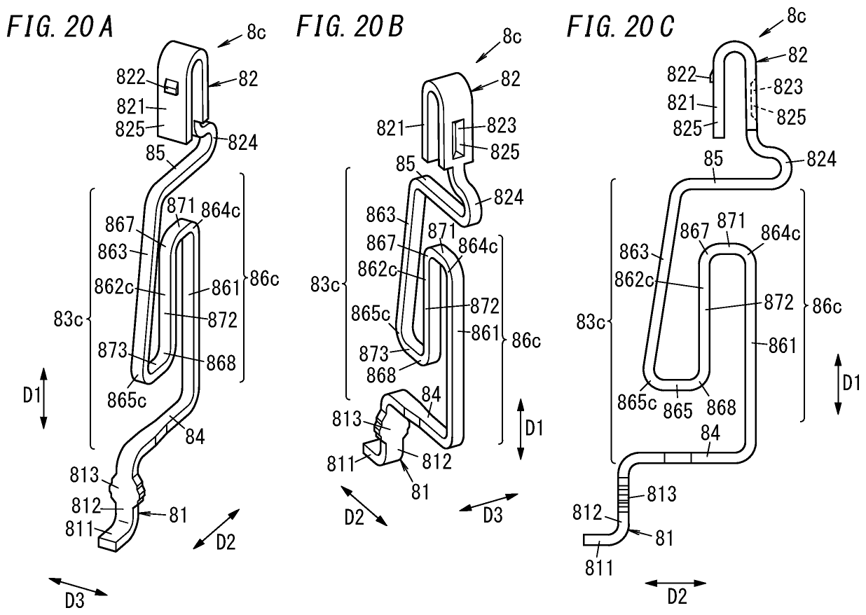

In a third variation of the embodiment, a connector 2 may include a contact 8c as shown in FIG. 20A to FIG. 20C. As with the contacts 8 of the embodiment (see FIG. 2), a plurality of the contacts 8c are arranged side by side along the longitudinal direction of a movable housing 7 (see FIG. 2).

Each contact 8c includes a first held part 81, a second held part 82, and an elastic part 83c. The first held part 81 and the second held part 82 of the third variation are the same as the first held part 81 and the second held part 82 of the embodiment (see FIG. 4A to FIG. 4C).

The elastic part 83c includes a first extension part 84, a second extension part 85, and an intermediate part 86c. The first extension part 84 and the second extension part 85 of the third variation are the same as the first extension part 84 and the second extension part 85 of the embodiment (see FIG. 4A to FIG. 4C).

The intermediate part 86c has a nearly N-shape and flexible both in a first-axis direction D1 and a second-axis direction D2. The intermediate part 86c includes an inside part 861, a middle part 862c, and an outside part 863. The inside part 861 and the outside part 863 of the third variation are the same as the inside part 861 and the outside part 863 of the embodiment (see FIG. 4A to FIG. 4C).

The middle part 862c includes a plurality of (three, in the illustrated example) middle pieces 871 to 873. The middle piece 871 extends in the second-axis direction D2. The middle piece 871 is parallel to the first extension part 84 and the second extension part 85. The middle piece 872 is provided between the middle piece 871 and the middle piece 873. The middle piece 872 extends in the first-axis direction D1. The middle piece 872 is orthogonal to each of the first extension part 84 and the second extension part 85. The middle piece 873 extends in the second-axis direction D2. The middle piece 873 is parallel to the first extension part 84 and the second extension part 85.

The intermediate part 86c includes a plurality of (four, in the illustrated example) curved parts 864c, 865c, 867, and 868. The number of curved parts of the fourth variation is larger than the number of curved parts of the embodiment. The number of curved parts provided in the middle part is not limited to two as in the embodiment or four as in the fourth variation, but may be three, five or more. The intermediate part 86c may include a plurality of curved parts. Alternatively, the number of curved parts may be one. The intermediate part 86c may include at least one curved part.

The curved part 864c is provided between the inside part 861 and the middle piece 871. The curved part 864c is provided such that the inside part 861 and the middle piece 871 form a substantially right angle. The curved part 865c is provided between the outside part 863 and the middle piece 873. The curved part 865c is provided such that the outside part 863 and the middle piece 873 form a substantially right angle. The curved part 867 is provided between the middle piece 871 and the middle piece 872. The curved part 867 is provided such that the middle piece 871 and the middle piece 872 form a substantially right angle. The curved part 868 is provided between the middle piece 872 and the middle piece 873. The curved part 868 is provided such that the middle piece 872 and the middle piece 873 form a substantially right angle.

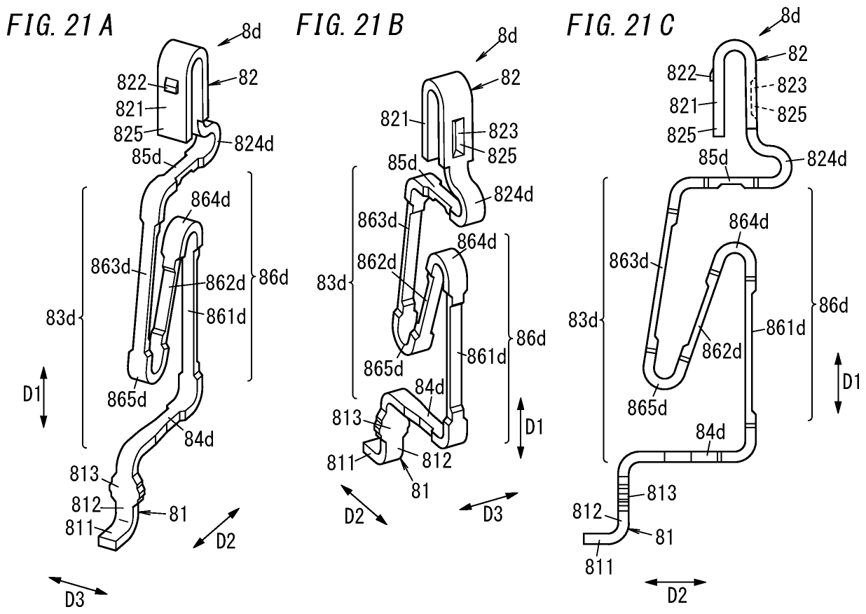

In a fourth variation of the embodiment, a connector 2 may include a contact 8d as shown in FIG. 21A to FIG. 21C. The contact 8d has different widths and thicknesses within its elastic part 83d. As with the contacts 8 of the embodiment (see FIG. 2), a plurality of the contacts 8d are arranged side by side along the longitudinal direction of a movable housing 7 (see FIG. 2).

Each contact 8d includes a first held part 81, a second held part 82, and the elastic part 83d. The first held part 81 and the second held part 82 of the fourth variation are the same as the first held part 81 and the second held part 82 of the embodiment (see FIG. 4A to FIG. 4C).

As shown in FIG. 21A to FIG. 21C, the second held part 82 of the fourth variation includes a base piece 821, a protrusion 822, and a recess 823, as with the second held part 82 of the embodiment. The second held part 82 further includes a folded part 824d. The folded part 824d has the width wider than the width of the folded part 824 of the embodiment (see FIG. 4A to FIG. 4C). The base piece 821, the protrusion 822, and the recess 823 of the second held part 82 of the fourth variation are the same as the base piece 821, the protrusion 822, and the recess 823 of the second held part 82 of the embodiment (see FIG. 4A to FIG. 4C).

The elastic part 83d includes a first extension part 84d (extension part), a second extension part 85d (extension part), and an intermediate part 86d.

The first extension part 84d extends in a direction intersecting with a first-axis direction D1 from the first held part 81. Specifically, the first extension part 84d extends in a second-axis direction D2. The width at a central part of the first extension part 84d is smaller than the width at each end part of the first extension part 84d. Specifically, in its width direction (third-axis direction D3), the central part of the first extension part 84d is thinner than each end part thereof. Moreover, in its thickness direction (first-axis direction D1), the central part of the first extension part 84d is thinner than each end part thereof.

The second extension part 85d extends in a direction intersecting with the first-axis direction D1 from the second held part 82. Specifically, the second extension part 85d extends in the second-axis direction D2. The width at a central part of the second extension part 85d is smaller than the width at each end part of the second extension part 85d. Specifically, in its width direction (third-axis direction D3), the central part of the second extension part 85d is thinner than each end part thereof. Moreover, in its thickness direction (first-axis direction D1), the central part of the second extension part 85d is thinner than each end part thereof.

The intermediate part 86d has an N-shape and flexible both in the first-axis direction D1 and the second-axis direction D2. The intermediate part 86d includes an inside part 861d, a middle part 862d, and an outside part 863d. The intermediate part 86d further includes a pair of curved parts 864d, 865d.

The width at a central part of the inside part 861d is smaller than the width at each end part of the inside part 861d. Specifically, in its width direction (third-axis direction D3), the central part of the inside part 861d is thinner than each end part thereof. Moreover, in its thickness direction (second-axis direction D2), the central part of the inside part 861d is thinner than each end part thereof.

The width at a central part of the middle part 862d is smaller than the width at each end part of the middle part 862d. Specifically, in its width direction (third-axis direction D3), the central part of the middle part 862d is thinner than each end part thereof. Moreover, in its thickness direction, the central part of the middle part 862d is thinner than each end part thereof.

The width at a central part of the outside part 863d is smaller than the width at each end part of the outside part 863d. Specifically, in its width direction (third-axis direction D3), the central part of the outside part 863d is thinner than each end part thereof. Moreover, in its thickness direction, the central part of the outside part 863d is thinner than each end part thereof.

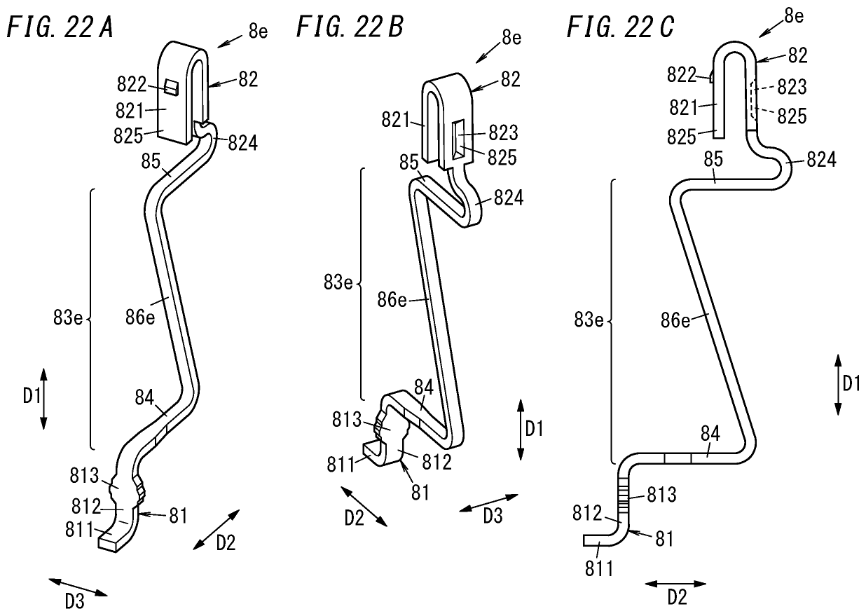

In a fifth variation of the embodiment, a connector 2 may include a contact 8e as shown in FIG. 22A to FIG. 22C. As with the contacts 8 of the embodiment (see FIG. 2), a plurality of the contacts 8e are arranged side by side along the longitudinal direction of a movable housing 7 (see FIG. 2).

Each contact 8e includes a first held part 81, a second held part 82, and an elastic part 83e.

The elastic part 83e includes a first extension part 84, a second extension part 85, and an intermediate part 86e. The intermediate part 86e has a linear shape, not the N-shape. The intermediate part 86e includes no curved part. The elastic part 83e has a first end connected to the first held part 81, and a second end connected to the second held part 82.

The intermediate part 86e extends in a direction intersecting with a first-axis direction D1. Specifically, the intermediate part 86e extends leftward as going toward the second extension part 85 in the first-axis direction D1, as well as extends rightward as going toward the first extension part 84 in the first-axis direction D1. The left in this variation means the outer side when the contact 8e is fixed to the movable housing 7 (see FIG. 8). The right in this variation means the inner side when the contact 8e is fixed to the movable housing 7.

In the connector 2 according to the fifth variation, the intermediate part 86e extends in a direction intersecting with the first-axis direction D1. The contact 8e can ensure the elasticity with a simple structure.

In another variation, a held part (first held part 81, second held part 82) may be held by a method other than the press-fitting. For example, a held part (first held part 81, second held part 82) may be held by way of an insert molding, crimped connection, adhesion or the like.

The connectors 2 according to the variations have the same or similar advantages of those of the connector 2 according to the embodiment.

The embodiment and the variations described above are mere some examples of various embodiments and the variations of the present disclosure. The above described embodiments and variations may be modified in various ways in accordance with design or the like as long as the object of the present disclosure can be achieved.

(Aspects)

The present disclosure discloses the following aspects.

A connector (2) according to a first aspect is configured to be fitted to a mating connector (3) in a first-axis direction (D1). The connector (2) includes a stationary housing (4), a movable housing (7), and a contact (8; 8a to 8e). The movable housing (7) is movable relative to the stationary housing (4). The contact (8) has electric conductivity. The contact (8) includes a first held part (81), a second held part (82), and an elastic part (83; 83a to 83e). The first held part (81) is held by the stationary housing (4). The second held part (82) is held by the movable housing (7). The elastic part (83; 83a to 83e) has elasticity and connects between the first held part (81) and the second held part (82). The elastic part (83; 83a to 83e) includes an extension part (first extension part 84; 84a; 84d, second extension part 85; 85a; 85d). The extension part extends in a second-axis direction (D2) intersecting with the first-axis direction (D1) from at least one of the first held part (81) or the second held part (82).

The first aspect of the connector (2) contributes to reduce the sizes of the contact (8; 8a to 8e) and the connector (2) with the elasticity of the contact (8; 8a to 8e) ensured.

In the connector (2) according to a second aspect, which may be implemented in conjunction with the first aspect, the elastic part (83; 83a to 83e) further includes an intermediate part (86; 86b to 86e). The intermediate part (86; 86b to 86e) has an N-shape and is flexible in a direction intersecting with the first-axis direction (D1). The elastic part (83; 83a to 83e) includes, as the extension part, a first extension part (84; 84a; 84d) and a second extension part (85; 85a; 85d). The first extension part (84; 84a; 84d) extends from the first held part (81) to be provided between the intermediate part (86; 86b to 86e) and the first held part (81). The second extension part (85; 85a; 85d) extends from the second held part (82) to be provided between the intermediate part (86; 86b to 86e) and the second held part (82).

The second aspect of the connector (2) contributes to increase the elasticity of the contact (8; 8a to 8e), and further reduce the sizes of the contact (8; 8a to 8e) and the connector (2).

In the connector (2) according to a third aspect, which may be implemented in conjunction with the second aspect, the first extension part (84; 84a; 84d) and the second extension part (85; 85a; 85d) are arranged in the first-axis direction (D1).

The third aspect of the connector (2) contributes to increase the elasticity in the first-axis direction (D1) of the contact (8; 8a to 8e).

In the connector (2) according to a fourth aspect, which may be implemented in conjunction with the third aspect, a direction in which the first extension part (84; 84a; 84d) protrudes from the first held part (81) and a direction in which the second extension part (85; 85a; 85d) protrudes from the second held part (82) are opposite to each other. The intermediate part (86; 86b to 86d) connects between a protruding end of the first extension part (84; 84a; 84d) and a protruding end of the second extension part (85; 85a; 85d) so as to reverse an extending direction.

The fourth aspect of the connector (2) contributes to increase the elasticity of the elastic part (83; 83a to 83d), i.e., the elasticity of the contact (8; 8a to 8d).

In the connector (2) according to a fifth aspect, which may be implemented in conjunction with the fourth aspect, the intermediate part (86; 86b to 86d) includes at least one curved part (864, 865; 864b to 864d, 865b to 865d).

The fifth aspect of the connector (2) contributes to readily increase the elasticity of the elastic part (83; 83a to 83d), i.e., the elasticity of the contact (8; 8a to 8d).

In the connector (2) according to a sixth aspect, which may be implemented in conjunction with the fifth aspect, the at least one curved part includes a plurality of curved parts (864, 865; 864b to 864d, 865b to 865d).

The sixth aspect of the connector (2) contributes to further increase the elasticity of the elastic part (83; 83a to 83d), i.e., the elasticity of the contact (8; 8a to 8d).

In the connector (2) according to a seventh aspect, which may be implemented in conjunction with the sixth aspect, the plurality of curved parts includes a pair of curved parts (864, 865; 864b to 864d, 865b to 865d) that are convex toward opposite directions to each other.

The seventh aspect of the connector (2) contributes to efficiently increase the elasticity with the small number of curved parts.

In the connector (2) according to an eighth aspect, which may be implemented in conjunction with the seventh aspect, the pair of curved parts (864, 865; 864b to 864d, 865b to 865d) are convex toward the opposite directions along the first-axis direction (D1).

The eighth aspect of the connector (2) contributes to further increase the elasticity in a direction intersecting with the first-axis direction (D1).

In the connector (2) according to a ninth aspect, which may be implemented in conjunction with any one of the second to eighth aspects, at least part of the intermediate part (86; 86b to 86e) overlaps the extension part (first extension part 84; 84a; 84d, second extension part 85; 85a; 85d) as seen in the first-axis direction (D1).

The ninth aspect of the connector (2) contributes to make the contact (8; 8a to 8e) in a compact size with the elasticity ensured.

In the connector (2) according to a tenth aspect, which may be implemented in conjunction with any one of the second to ninth aspects, the intermediate part (86; 86b to 86d) has a vertex part (866) overlapping the movable housing (7) as seen in the first-axis direction (D1).

The tenth aspect of the connector (2) contributes to reduce the width in a direction intersecting with the first-axis direction (D1) of the connector (2), compared to a structure where a vertex par of an intermediate part does not overlap a movable housing. This aspect thus contributes to reduce the size of the connector (2).

In the connector (2) according to an eleventh aspect, which may be implemented in conjunction with any one of the first to tenth aspects, at least one of the first held part (81) or the second held part (82) includes a folded part (824). The folded part (824) is provided at a connection part, connected to the extension part (first extension part 84; 84a; 84d, second extension part 85; 85a; 85d), of the at least one of the first held part (81) or the second held part (82).

The eleventh aspect of the connector (2) contributes to make it possible to readily ensure the length of the held part (first held part 81, second held part 82), thus contributes to increase the elasticity in the first-axis direction (D1) of the contact (8; 8a to 8e).

In the connector (2) according to a twelfth aspect, which may be implemented in conjunction with any one of the first to eleventh aspects, a width of the elastic part (83; 83a to 83e) at either or both of a part in proximity to the first held part (81) and a part in proximity to the second held part (82) is greater than a width of a remaining part of the elastic part (83; 83a to 83e).

The twelfth aspect of the connector (2) contributes to increase the strength of the part (first extension part 84; 84a; 84d, second extension part 85; 85a; 85d) around the held part (first held part 81, second held part 82) which is to be held with the press-fitting.

In the connector (2) according to a thirteenth aspect, which may be implemented in conjunction with any one of the first to twelfth aspects, a plurality of the contacts (8; 8a to 8e) are arranged side by side along a longitudinal direction of the movable housing (7). As to two contacts (8; 8a to 8e) adjacent to each other of the plurality of contacts (8; 8a to 8e), at least one of the stationary housing (4) or the movable housing (7) is present between the first held parts (81) of the two contacts (8; 8a to 8e) or between the second held parts (82) of the two contacts (8; 8a to 8e). None of the stationary housing (4) and the movable housing (7) is present between the elastic parts (83; 83a to 83e) of the two contacts (8; 8a to 8e).

The thirteenth aspect of the connector (2) contributes to make the region between the adjacent two contacts (8; 8a to 8e) to have a low dielectric property to enhance the transmission property.

In the connector (2) according to a fourteenth aspect, which may be implemented in conjunction with any one of the second to tenth aspects, the second held part (82) includes a contacting part (825). The contacting part (825) is configured to be in contact with the mating connector (3) when the connector (2) is fitted to the mating connector (3). The intermediate part (86; 86b to 86e) extends in a direction intersecting with the first-axis direction (D1).

The fourteenth aspect of the connector (2) contributes to ensure the elasticity of the contact (8; 8a to 8e) with a simplified structure.

In the connector (2) according to a fifteenth aspect, which may be implemented in conjunction with any one of the second to tenth aspects, the intermediate part (86; 86b to 86e) includes a middle part (862; 862b to 862d) extending in a direction intersecting with the first-axis direction (D1).

In the fifteenth aspect of the connector (2), the intermediate part (86; 86b to 86d) includes the middle part (862; 862b to 862d) extending in the direction intersecting with the first-axis direction (D1). This aspect thus contributes to ensure the elasticity with a simplified structure.

In the connector (2) according to a sixteenth aspect, which may be implemented in conjunction with any one of the second to tenth aspects, the intermediate part (86; 86b to 86e) includes a part facing the stationary housing (4), and a distance between the part facing the stationary housing of the intermediate part and the stationary housing (4) decreases as going away from the mating connector (3) in the first-axis direction (D1).

With the connector (2) according to the sixteenth aspect, the contact (8; 8a to 8e) is less likely to come in contact with the stationary housing (4) when the contact (8; 8a to 8e) is deformed. This aspect thus can ensure a large space for the contact (8; 8a to 8e) to move thereinside.

A connection apparatus (1) according to a seventeenth aspect includes the connector (2) according to any one of the first to sixteenth aspects, and the mating connector (3).

The seventeenth aspect of the connection apparatus (1) contributes to reduce the sizes of the contact (8; 8a to 8e) and the connector (2) with the elasticity of the contact (8; 8a to 8e) ensured in the connector (2).

A connection method according to an eighteenth aspect is a connection method of a connection apparatus (1) including a connector (2) and a mating connector (3) configured to be fitted to each other in a first-axis direction (D1). The connector (2) includes a stationary housing (4), a movable housing (7), and a contact (8; 8a to 8e). The movable housing (7) is movable relative to the stationary housing (4). The contact (8; 8a to 8e) has electric conductivity. The contact (8; 8a to 8e) includes a first held part (81), a second held part (82), and an elastic part (83; 83a to 83e). The first held part (81) is held by the stationary housing (4). The second held part (82) is held by the movable housing (7). The elastic part (83; 83a to 83e) has elasticity and connects between the first held part (81) and the second held part (82). The connection method includes a first step, a second step, a third step, a fourth step, and a fifth step. The first step includes preparing the connector (2) mounted on a first substrate (91) and the mating connector (3) mounted on a second substrate (92). The second step includes bringing, from a state where the connector (2) and the mating connector (3) are out of contact with each other, the mating connector (3) into contact with the connector (2). The third step includes, after the second step of bringing the mating connector (3) into contact with the connector (2), applying a load to at least one of the connector (2) or the mating connector (3) while keeping a place of point in contact between the connector (2) and the mating connector (3) to change a relative position of the mating connector (3) to the connector (2) until the movable housing (7) comes into contact with the first substrate (91). The fourth step includes applying a load to at least one of the connector (2) or the mating connector (3) to make the connector (2) and the mating connector (3) fit to each other. The fifth step includes removing the load from the connector (2) and the mating connector (3).

The eighteenth aspect of the connection method contributes to realize a connection between the connector (2) and the mating connector (3) with the connector (2) and the mating connector (3) electrically connected with each other. As a result, the first substrate (91) and the second substrate (92) can be electrically connected to each other via the connection apparatus (1).

In the connection method according to a nineteenth aspect, which may be implemented in conjunction with the eighteenth aspect, the fourth step includes applying the load to at least one of the connector (2) or the mating connector (3) while keeping a state where the movable housing (7) is in contact with the first substrate (91) to make the connector (2) and the mating connector (3) fit to each other.

The nineteenth aspect of the connection method contributes to improve the reliability of the connection between the connector (2) and the mating connector (3) with the movable housing (7) pressed toward the first substrate (91).

### REFERENCE SIGNS LIST

1 Connection Apparatus
2 Connector
3 Mating Connector
4 Stationary Housing
7 Movable Housing
8, 8a to 8e Contact
81 First Held Part
82 Second Held Part
824 Folded Part
825 Contacting Part
83, 83a to 83e Elastic Part
84, 84a, 84d First Extension Part (Extension Part)
85, 85a, 85d Second Extension Part (Extension Part)
86, 86b to 86e Intermediate Part
864, 864b to 864d, 865, 865b to 865d, 867, 868 Curved Part
866 Vertex Part
91 First Substrate
92 Second Substrate
L1 to L3 Thickness
D1 First-axis direction
D2 Second-axis direction
D3 Third-axis direction

1. A connector configured to be fitted to a mating connector in a first-axis direction, the connector comprising:
a stationary housing;
a movable housing movable relative to the stationary housing; and
a contact having electric conductivity,
the contact including
a first held part held by the stationary housing,
a second held part held by the movable housing, and
an elastic part having elasticity and connecting between the first held part and the second held part, and
the elastic part including an extension part extending in a second-axis direction intersecting with the first-axis direction from at least one of the first held part or the second held part.

2. The connector of claim 1, wherein
the elastic part further includes an intermediate part having an N-shape and being flexible in a direction intersecting with the first-axis direction, and
the extension part of the elastic part includes
a first extension part extending from the first held part to be provided between the intermediate part and the first held part, and
a second extension part extending from the second held part to be provided between the intermediate part and the second held part.

3. The connector of claim 2, wherein the first extension part and the second extension part are arranged in the first-axis direction.

4. The connector of claim 3, wherein
a direction in which the first extension part protrudes from the first held part and a direction in which the second extension part protrudes from the second held part are opposite to each other, and
the intermediate part connects between a protruding end of the first extension part and a protruding end of the second extension part so as to reverse an extending direction.

5. The connector of claim 4, wherein
the intermediate part includes at least one curved part.

6. The connector of claim 5, wherein
the at least one curved part includes a plurality of curved parts.

7. The connector of claim 6, wherein
the plurality of curved parts includes a pair of curved parts that are convex toward opposite directions to each other.

8. The connector of claim 7, wherein
the pair of curved parts are convex toward the opposite directions along the first-axis direction.

9. The connector of claim 2, wherein
at least part of the intermediate part overlaps the extension part as seen in the first-axis direction.

10. The connector of claim 2, wherein
the intermediate part has a vertex part overlapping the movable housing as seen in the first-axis direction.

11. The connector of claim 1, wherein
at least one of the first held part or the second held part includes a folded part at a connection part connected to the extension part.

12. The connector of claim 1, wherein
a width of the elastic part at either or both of a part in proximity to the first held part and a part in proximity to the second held part is greater than a width of a remaining part of the elastic part.

13. The connector of claim 1, wherein
the connector includes a plurality of the contacts arranged side by side along a longitudinal direction of the movable housing,
the plurality of the contacts includes two contacts adjacent to each other,
at least one of the stationary housing or the movable housing being present between the first held parts of the two contacts or between the second held parts of the two contacts, and
none of the stationary housing and the movable housing being present between the elastic parts of the two contacts.

14. The connector of claim 2, wherein
the second held part includes a contacting part configured to be in contact with the mating connector when the connector is fitted to the mating connector,
the intermediate part extends in a direction intersecting with the first-axis direction.

15. The connector of claim 2, wherein
the intermediate part includes a middle part extending in a direction intersecting with the first-axis direction.

16. The connector of claim 2, wherein
the intermediate part has a part facing the stationary housing, a distance between the part facing the stationary housing of the intermediate part and the stationary housing decreasing as going away from the mating connector in the first-axis direction.

17. A connection apparatus, comprising:
the connector of claim 1; and
the mating connector.

18. A connection method of a connection apparatus including a connector and a mating connector configured to be fitted to each other in a first-axis direction,
the connector including
a stationary housing,
a movable housing movable relative to the stationary housing, and
a contact having electric conductivity,
the contact including
a first held part held by the stationary housing,
a second held part held by the movable housing, and
an elastic part having elasticity and connecting between the first held part and the second held part,
the connection method comprising:
a first step of preparing the connector mounted on a first substrate and the mating connector mounted on a second substrate;
a second step of bringing, from a state where the connector and the mating connector are out of contact with each other, the mating connector into contact with the connector,
a third step of, after the second step of bringing the mating connector into contact with the connector, applying a load to at least one of the connector or the mating connector while keeping a place of point in contact between the connector and the mating connector to change a relative position of the mating connector to the connector until the movable housing comes into contact with the first substrate;
a fourth step of applying a load to at least one of the connector or the mating connector to make the connector and the mating connector fit to each other; and
a fifth step of removing the load from the connector and the mating connector.

19. The connection method of claim 18, wherein
the fourth step includes applying the load to at least one of the connector or the mating connector while keeping a state where the movable housing is in contact with the first substrate to make the connector and the mating connector fit to each other.
